(19) United States
(12) Patent Application Publication
(10) Pub. No.: US 2010/0274555 A1
(43) Pub. Date: Oct. 28, 2010

(54) Audio Coding Apparatus and Method Thereof

(76) Inventors: Lasse Laaksonen, Nokia (FI); Mikko Tammi, Tampere (FI); Adriana Vasilache, Tampere (FI); Anssi Ramo, Tampere (FI)

Correspondence Address: HARRINGTON & SMITH, 4 RESEARCH DRIVE, Suite 202, SHELTON, CT, 06484-6212, US

(21) Appl. No.: 12/741,636

(22) PCT Filed: Nov. 6, 2007
(86) PCT No.: PCT/EP07/61915

§ 371 Date: Jun. 14, 2010

(51) Int. Cl. G10L 19/00

(52) U.S. Cl. 704/201

(57) ABSTRACT

An apparatus comprising at least one processor and at least one memory including computer program code the at least one memory and the computer program code configured to, with the at least one processor, cause the apparatus at least to determine at least one characteristic of the audio signal; divide the audio signal into at least a low frequency portion and a high frequency portion, and generate from the high frequency portion a plurality of high frequency band signals dependent on the at least one characteristic of the audio signal; and determine for each of the plurality of high frequency band signals at least part of the low frequency portion which can represent the high frequency band signal.

### FIELD OF THE INVENTION

The present invention relates to coding, and in particular, but not exclusively to speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

In some audio codecs the input signal is divided into a limited number of bands. Each of the band signals may be quantized. From the theory of psychoacoustics it is known that the highest frequencies in the spectrum are perceptually less important than the low frequencies. This in some audio codecs is reflected by a bit allocation where fewer bits are allocated to high frequency signals than low frequency signals.

Furthermore in some codecs use the correlation between the low and high frequency bands or regions of an audio signal to improve the coding efficiency with the codecs.

As typically the higher frequency bands of the spectrum are generally quite similar to the lower frequency bands some codecs may encode only the lower frequency bands and reproduce the upper frequency bands as a scaled lower frequency band copy. Thus by only using a small amount of additional control information considerable savings can be achieved in the total bit rate of the codec.

One such codec for coding the high frequency region is known as high frequency region (HFR) coding. One form of high frequency region coding is spectral-band-replication (SBR), which has been developed by Coding Technologies. In SBR, a known audio coder, such as Moving Pictures Expert Group MPEG-4 Advanced Audio Coding (AAC) or MPEG-1 Layer III (MP3) coder, codes the low frequency region. The high frequency region is generated separately utilizing the coded low frequency region.

In HFR coding, the high frequency region is obtained by transposing the low frequency region to the higher frequencies. The transposition is based on a Quadrature Mirror Filters (QMF) filter bank with 32 bands and is performed such that it is predefined from which band samples each high frequency band sample is constructed. This is done independently of the characteristics of the input signal.

The higher frequency bands are filtered based on additional information. The filtering is done to make particular features of the synthesized high frequency region more similar with the original one. Additional components, such as sinusoids or noise, are added to the high frequency region to increase the similarity with the original high frequency region. Finally, the envelope is adjusted to follow the envelope of the original high frequency spectrum.

In PCT published application WO 2007/052088 a further HFR codec is proposed which divides the high frequency band into a number of bands and then selects a band from the encoded low frequency band which is similar to each high frequency band.

Specifically WO 2007/052088 operating in the Modified Discrete Cosine Transform (MDCT) domain divides the high-frequency region of the original signal into N_{b} bands and the best fit from the coded low-frequency region is used for transposing.

For each of the N_{b} bands the most similar band is searched and its index (or start frequency) is transmitted to enable the use of the said low-frequency band for generating the high-frequency band in the decoder. In this process, the selected low-frequency band is then scaled in two steps to match the high-amplitude peaks of the original signal and to match its overall energy.

Although the search of the lower frequencies generally provides an improved match to the original signal's high-frequency region in comparison to the previous methods that simply transpose the low-frequency region to the high-frequency region, the match can still be suboptimal when the spectral properties differ significantly from the high-frequency region. It may then become difficult to find a good fit for the band from the low-frequency region.

### SUMMARY OF THE INVENTION

This invention proceeds from the consideration that the currently proposed codecs lack flexibility with respect to being able to select appropriate bands from the lower frequency range.

Embodiments of the present invention aim to address the above problem.

There is provided according to a first aspect of the present invention an encoder for encoding an audio signal, wherein the encoder is configured to: determine at least one characteristic of the audio signal; divide the audio signal into at least a low frequency portion and a high frequency portion, and generate from the high frequency portion a plurality of high frequency band signals dependent on the at least one characteristic of the audio signal; and determine for each of the plurality of high frequency band signals at least part of the low frequency portion which can represent the high frequency band signal.

The encoder may further be configured to: store at least a plurality of band allocations; and select one of the plurality of band allocations dependent on the at least one characteristic of the audio signal, wherein the encoder is configured to generate the plurality of high frequency band signals from the application of the selected band allocation to the high frequency portion of the audio signal.

The encoder may further be configured to: generate a band allocation dependent on the at least one characteristic of the audio signal; wherein the encoder is configured to generate the plurality of high frequency band signals from the application of the generated band allocation to the high frequency portion of the audio signal.

Each band allocation may comprise a plurality of bands.

Each band may comprise at least one of: a location frequency and a bandwidth; and a start frequency and a stop frequency.

At least one band of the plurality of bands may overlap at least partially with at least one further band of the plurality of bands.

The encoder may further be configured to generate a band allocation signal dependent on the generated plurality of high frequency band signals.

The encoder may further be configured to: generate a low frequency encoded signal dependent on the low frequency portion of the audio signal; generate a high frequency encoded signal dependent on the determined at least part of the low frequency portion which can represent the high frequency band signal; and output an encoded signal comprising: the low frequency encoded signal; the high frequency encoded signal; and the band allocation signal.

The at least one characteristic of the audio signal may comprise characteristics determined only from the high frequency portion of the audio signal.

The at least one characteristic of the audio signal may comprise: energy of components of the audio signal; peak to valley ratio of components of the audio signal; and bandwidth of the audio signal.

According to a second aspect of the invention there is provided a method for encoding an audio signal, comprising: determining at least one characteristic of the audio signal; dividing the audio signal into at least a low frequency portion and a high frequency portion, and generating from the high frequency portion a plurality of high frequency band signals dependent on the at least one characteristic of the audio signal; and determining for each of the plurality of high frequency band signals at least part of the low frequency portion which can represent the high frequency band signal.

The method may further comprise: storing at least a plurality of band allocations; and selecting one of the plurality of band allocations dependent on the at least one characteristic of the audio signal, wherein generating the plurality of high frequency band signals may comprise applying the selected band allocation to the high frequency portion of the audio signal.

The method may further comprise: generating a band allocation dependent on the at least one characteristic of the audio signal; wherein generating the plurality of high frequency band signals may comprise applying the generated band allocation to the high frequency portion of the audio signal.

Each band allocation preferably comprises a plurality of bands.

Each band preferably comprises at least one of: a location frequency and a bandwidth; and a start frequency and a stop frequency.

At least one band of the plurality of bands is preferably overlapping at least partially with at least one further band of the plurality of bands.

The method may further comprise generating a band allocation signal dependent on the generated plurality of high frequency band signals.

The method may further comprise: generating a low frequency encoded signal dependent on the low frequency portion of the audio signal; generating a high frequency encoded signal dependent on the determined at least part of the low frequency portion which can represent the high frequency band signal; and outputting an encoded signal comprising: the low frequency encoded signal; the high frequency encoded signal; and the band allocation signal.

The at least one characteristic of the audio signal preferably comprises characteristics determined only from the high frequency portion of the audio signal.

The at least one characteristic of the audio signal preferably comprises: energy of components of the audio signal; peak to valley ratio of components of the audio signal; and bandwidth of the audio signal.

According to a third aspect of the invention there is provided a decoder for decoding an audio signal, wherein the decoder is configured to: receive an encoded signal comprising: a low frequency encoded signal; a high frequency encoded signal; and a band allocation signal; and decode the low frequency encoded signal to produce a synthetic low frequency signal; generate a synthetic high frequency signal, wherein at least one part of the synthetic high frequency signal dependent on the band allocation signal is generated from at least a portion of the synthetic low frequency signal dependent on at least a part of the high frequency signal.

The decoder may be further configured to combine the synthetic low frequency signal and synthetic high frequency signal to generate a decoded audio signal.

The decoder may further be configured to: store at least a plurality of band allocations; and select one of the plurality of band allocations dependent on the band allocation signal.

The decoder may further be configured to: generate a band allocation dependent on the band allocation signal.

Each band allocation may comprise a plurality of bands.

Each band may comprise at least one of: a location frequency and a bandwidth; and a start frequency and a stop frequency.

According to a fourth aspect of the present invention there is provided a method for decoding an audio signal, comprising: receiving an encoded signal comprising: a low frequency encoded signal; a high frequency encoded signal; and a band allocation signal; and decoding the low frequency encoded signal to produce a synthetic low frequency signal; generating a synthetic high frequency signal, wherein at least one part of the synthetic high frequency signal dependent on the band allocation signal is generated from at least a portion of the synthetic low frequency signal dependent on at least a part of the high frequency signal.

The method may further comprise combining the synthetic low frequency signal and synthetic high frequency signal to generate a decoded audio signal.

The method may further comprise: storing at least a plurality of band allocations; and selecting one of the plurality of band allocations dependent on the band allocation signal.

The method may further comprise: generating a band allocation dependent on the band allocation signal.

Each band allocation preferably comprises a plurality of bands.

Each band preferably comprises at least one of: a location frequency and a bandwidth; and a start frequency and a stop frequency.

According to a fifth aspect of the present invention there is provided an apparatus comprising an encoder as described above.

According to a sixth aspect of the present invention there is provided an apparatus comprising a decoder as described above.

According to a seventh aspect of the present invention there is provided an electronic device comprising an encoder as described above.

According to an eighth aspect of the present invention there is provided an electronic device comprising a decoder as described above.

According to a ninth aspect of the present invention there is provided a computer program product configured to perform a method for encoding an audio signal, comprising: determining at least one characteristic of the audio signal; dividing the audio signal into at least a low frequency portion and a high frequency portion, and generating from the high frequency portion a plurality of high frequency band signals dependent on the at least one characteristic of the audio signal; and determining for each of the plurality of high frequency band signals at least part of the low frequency portion which can represent the high frequency band signal.

According to a tenth aspect of the present invention there is provided a computer program product configured to perform a method for decoding an audio signal, comprising: receiving an encoded signal comprising: a low frequency encoded signal; a high frequency encoded signal; and a band allocation signal; decoding the low frequency encoded signal to produce a synthetic low frequency signal; generating a synthetic high frequency signal, wherein at least one part of the synthetic high frequency signal dependent on the band allocation signal is generated from at least a portion of the synthetic low frequency signal dependent on at least a part of the high frequency signal.

According to an eleventh aspect of the present invention there is provided an encoder for encoding an audio signal comprising: determining means for determining at least one characteristic of the audio signal; filtering means for dividing the audio signal into at least a low frequency portion and a high frequency portion, and processing means for generating from the high frequency portion a plurality of high frequency band signals dependent on the at least one characteristic of the audio signal; and further determining means for determining for each of the plurality of high frequency band signals at least part of the low frequency portion which can represent the high frequency band signal.

According to a twelfth aspect of the present invention there is provided a decoder for decoding an audio signal, comprising: receiving means for receiving an encoded signal comprising: a low frequency encoded signal; a high frequency encoded signal; and a band allocation signal; and deciding means for decoding the low frequency encoded signal to produce a synthetic low frequency signal; processing means for generating a synthetic high frequency signal, wherein at least one part of the synthetic high frequency signal dependent on the band allocation signal is generated from at least a portion of the synthetic low frequency signal dependent on at least a part of the high frequency signal.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio codec system employing embodiments of the present invention;

FIG. 3 shows schematically an encoder part of the audio codec system shown in FIG. 2;

FIG. 4 shows schematically a decoder part of the audio codec system shown in FIG. 2;

FIG. 5 shows an example of an audio signal spectrum;

FIG. 6 shows part of the audio signal spectrum of FIG. 5 with examples of the frequency bands as employed in embodiments of the invention;

FIG. 7 shows a flow diagram illustrating the operation of an embodiment of the audio encoder as shown in FIG. 3 according to the present invention; and

FIG. 8 shows a flow diagram illustrating the operation of an embodiment of the audio decoder as shown in FIG. 3 according to the present invention.

### DESCRIPTION OF PREFERRED EMBODIMENTS OF THE INVENTION

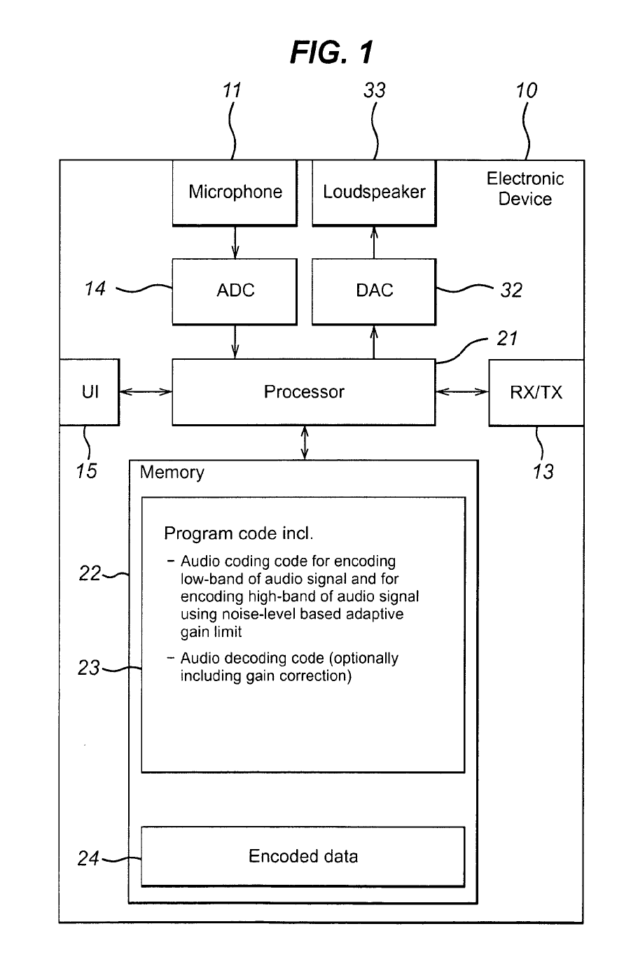

The following describes in more detail possible codec mechanisms for the provision of layered or scalable variable rate audio codecs. In this regard reference is first made to FIG. 1 schematic block diagram of an exemplary electronic device 10, which may incorporate a codec according to an embodiment of the invention.

The electronic device 10 may for example be a mobile terminal or user equipment of a wireless communication system.

The electronic device 10 comprises a microphone 11, which is linked via an analogue-to-digital converter 14 to a processor 21. The processor 21 is further finked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes comprise an audio encoding code for encoding a lower frequency band of an audio signal and a higher frequency band of an audio signal. The implemented program codes 23 further comprise an audio decoding code. The implemented program codes 23 may be stored for example in the memory 22 for retrieval by the processor 21 whenever needed. The memory 22 could further provide a section 24 for storing data, for example data that has been encoded in accordance with the invention.

The encoding and decoding code may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 converts the input analogue audio signal into a digital audio signal and provides the digital audio signal to the processor 21.

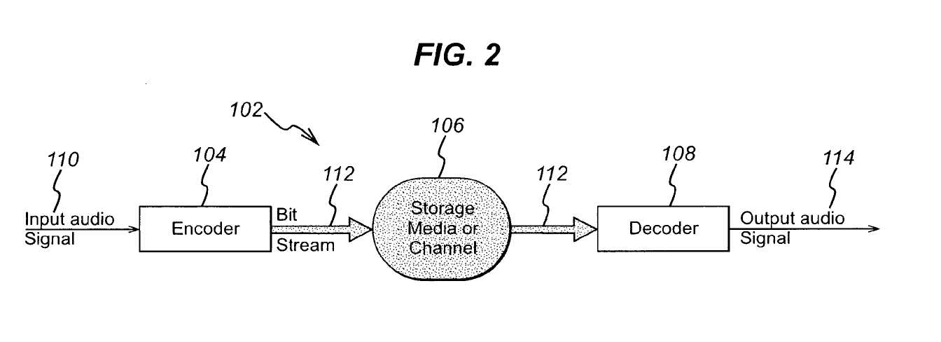

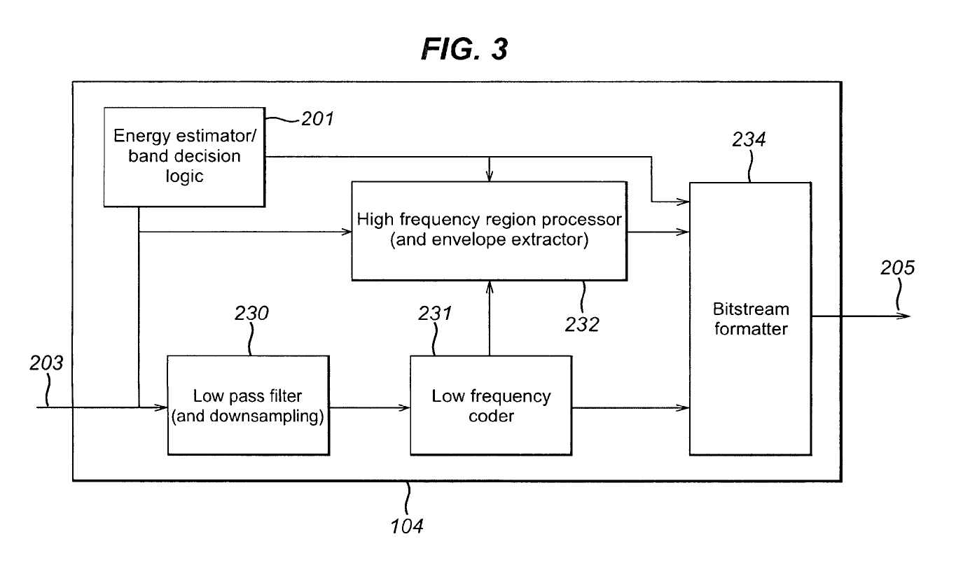

The processor 21 may then process the digital audio signal in the same way as described with reference to FIGS. 2 and 3.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 could also receive a bit stream with correspondingly encoded data from another electronic device via its transceiver 13. In this case, the processor 21 may execute the decoding program code stored in the memory 22. The processor 21 decodes the received data, and provides the decoded data to the digital-to-analogue converter 32. The digital-to-analogue converter 32 converts the digital decoded data into analogue audio data and outputs them via the loudspeakers 33. Execution of the decoding program code could be triggered as well by an application that has been called by the user via the user interface 15.

The received encoded data could also be stored instead of an immediate presentation via the loudspeakers 33 in the data section 24 of the memory 22, for instance for enabling a later presentation or a forwarding to still another electronic device.

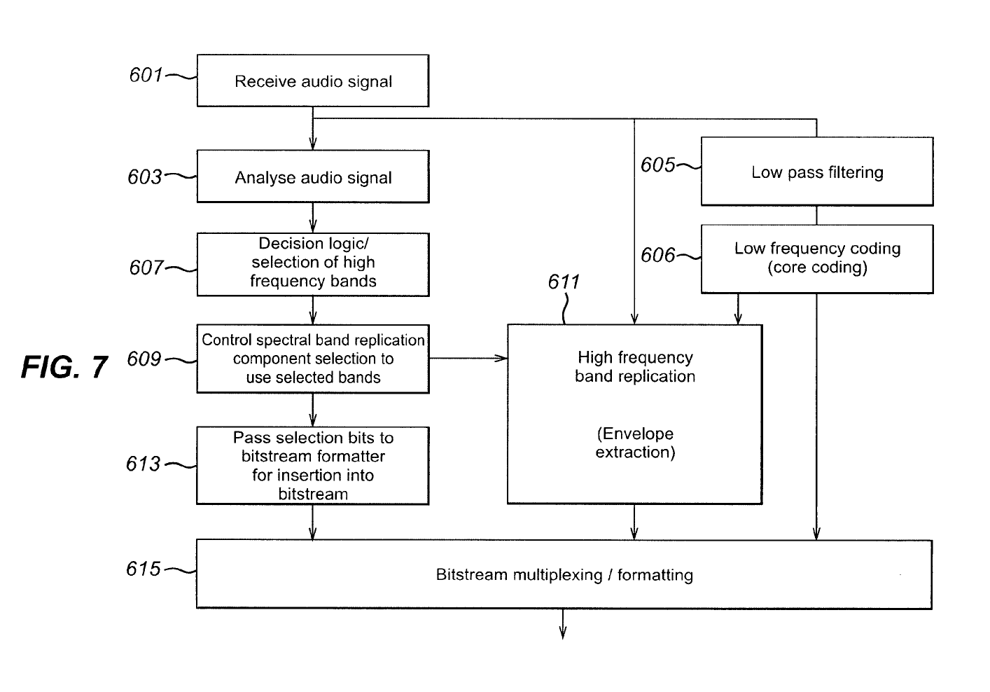

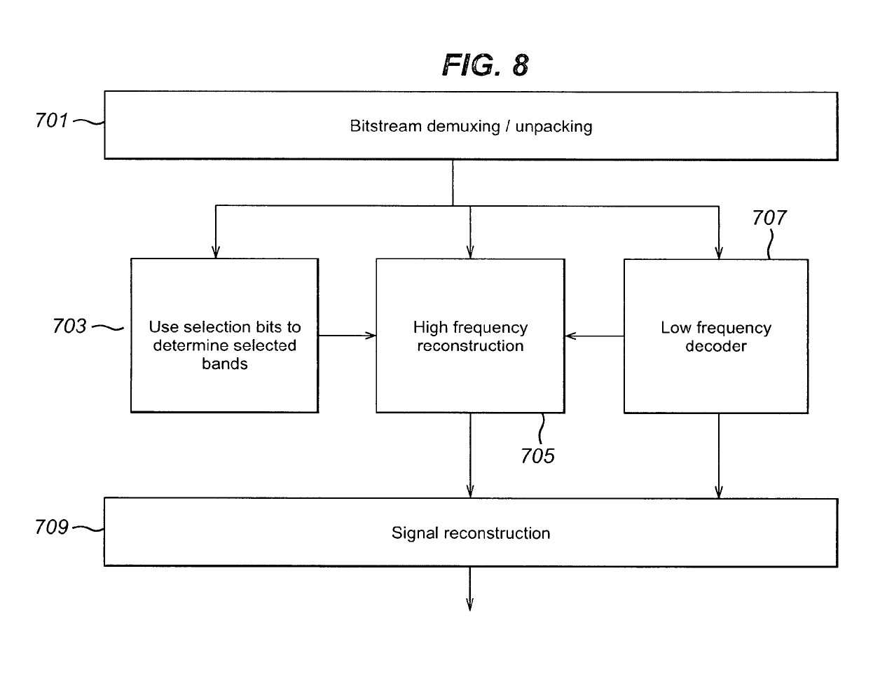

It would be appreciated that the schematic structures described in FIGS. 2 to 4 and the method steps in FIGS. 7 and 8 represent only a part of the operation of a complete audio codec as exemplarily shown implemented in the electronic device shown in FIG. 1.

The general operation of audio codecs as employed by embodiments of the invention is shown in FIG. 2. General audio coding/decoding systems consist of an encoder and a decoder, as illustrated schematically in FIG. 2. Illustrated is a system 102 with an encoder 104, a storage or media channel 106 and a decoder 108.

The encoder 104 compresses an input audio signal 110 producing a bit stream 112, which is either stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features, which define the performance of the coding system 102.

FIG. 3 shows schematically an encoder 104 according to an embodiment of the invention. The encoder 104 comprises an input 203 arranged to receive an audio signal. The input 203 is connected to a low pass filter 230, high frequency region (HFR) processor 232 and signal energy estimator 201. The low pass filter 230 furthermore outputs a signal to the low frequency coder (otherwise known as the core codec) 231. The low frequency coder 231 and the signal energy estimator are further configured to output signals to the HFR processor 232. The low frequency coder 231, the signal energy estimator 201 and the HFR processor 232 are configured to output signals to the bitstream formatter 234 (which in some embodiments of the invention is also known as the bitstream multiplexer). The bitstream formatter 234 is configured to output the output bitstream 112 via the output 205.

The operation of these components is described in more detail with reference to the flow chart showing the operation of the coder 104.

The audio signal is received by the coder 104. In a first embodiment of the invention the audio signal is a digitally sampled signal. In other embodiments of the present invention the audio input may be an analogue audio signal, for example from a microphone 6, which is analogue to digitally (A/D) converted. In further embodiments of the invention the audio input is converted from a pulse code modulation digital signal to amplitude modulation digital signal. The receiving of the audio signal is shown in FIG. 7 by step 601.

The low pass filter 230 receives the audio signal and defines a cut-off frequency up to which the input signal 110 is filtered. 6a. The received audio signal frequencies below the cut-off frequency 36 pass the filter and are passed to the low frequency coder 231. In some embodiments of the invention the signal is optionally down sampled in order to further improve the coding efficiency of the low frequency coder 231. This filtering is shown in FIG. 7

The low frequency coder 231 receives the low frequency (and optionally down sampled) audio signal and applies a suitable low frequency coding upon the signal. In a first embodiment of the invention the low frequency coder 231 applies a quantization and Huffman coding with 32 low frequency sub-bands. The input signal 110 is divided into sub-bands using an analysis filter bank structure. Each sub-band may be quantized and coded utilizing the information provided by a psychoacoustic model. The quantization settings as well as the coding scheme may be dictated by the psychoacoustic model applied. The quantized, coded information is sent to the bit stream formatter 234 for creating a bit stream 12.

Furthermore the low frequency coder 231 furthermore converts the low frequency contents using a bank of quadrature mirror filters (QMF) to produce frequency domain realizations of each sub-band. These frequency domain realizations are passed to the HFR processor 232.

This low frequency coding is shown in FIG. 7 by step 606.

In other embodiments of the invention other low frequency codecs may be employed in order to generate the core coding output which is output to the bitstream formatter 234. Examples of these further embodiment low frequency codecs include but are not limited to advanced audio coding (AAC), MPEG layer 3 (MP3), the ITU-T Embedded variable rate (EV-VBR) speech coding baseline codec, and ITU-T G.729.1.

Where the low frequency coder does not effectively output a frequency domain sub-band output as part of the bitstream output the low frequency coder 231 may furthermore comprise a low frequency decoder and frequency domain converter (not shown in FIG. 3) to generate a synthetic reproduction of the low frequency signal and the synthetic reproduction of the low frequency signal is then converted into the frequency domain and, if needed, partitioned into a series of low frequency sub-bands which are sent to the HFR processor 232.

This allows the choice of the low frequency coder to be made from a wide range of possible coder/decoders and as such the invention is not limited to specific low frequency or core coder algorithms which produce frequency domain information as part of the output.

The audio signal is also received by the energy estimator 201. In the first embodiment of the invention the energy estimator 201 comprises a high pass filter (not shown) which passes the frequency components not passed in the low pass filter 605.

The high frequency audio signal is then converted into the frequency domain. The high frequency audio signal (the high frequency region of the signal) may be furthermore divided into short sub-bands. These sub-bands are in the order of 500-800 Hz wide. In a preferred embodiment the sub-band bandwidth is 750 Hz. In other embodiments of the invention the bandwidth of the sub-bands depend on the bandwidth allocation used. In a first embodiment of the invention the sub-band bandwidth is a fixed width—in other words each sub-band has the same width. In other embodiments of the invention the sub-band bandwidth is not constant but each sub-band may have a different bandwidth. In some embodiments of the invention this variable sub-band bandwidth allocation may be determined based on a psychoacoustic modeling of the audio signal. These sub-bands may furthermore be in various embodiments of the invention successive (in other words one after another and producing a continuous spectral realization) or partly overlapping.

The energy estimator 201 then determines the sub-band energy for each of the sub-bands.

In some embodiments of the invention different or additional properties of the high-frequency region are determined. Other properties include but are not limited to the peak-to-valley energy ratio of each sub-band and the signal bandwidth.

These properties of the high frequency regions are then further utilized in the energy estimator 201.

This analysis of the audio signal is shown in FIG. 7 by step 603.

In some embodiments of the invention the analysis of the audio signal within the energy estimator includes an analysis of the encoded low frequency region as well as the analysis of the original high frequency region. In further embodiments of the invention therefore the energy estimator determines properties of the effective whole of the spectrum by receiving the encoded low frequency signal and dividing these into short sub-bands to be analysed for example to determine the energy per ‘whole’ spectrum sub-band or/and the peak-to-valley energy ratio of each ‘whole’ spectrum sub-band.

In further embodiments of the invention the energy estimator further receives the encoded low frequency signal and (if required) divides these into short sub-bands to be analysed. The low frequency domain signal output from the encoder is then analysed in a similar way to the high frequency domain signal for example to determine the energy per low frequency domain sub-band or/and the peak-to-valley energy ratio of each low frequency domain sub-band.

The energy estimator 201 may partition the high frequency region into specific bands using decision logic examining the determined properties of the high frequency region. Thus based on the short sub-band energy estimations the number and lengths of bands may be selected. Thus, for example, the energy estimator decision logic 201 may locate a short but prominent energy peak and select the band lengths such that the located energy peak is contained in a single band. The band allocations (number of bands, band lengths, bit allocation for quantization) are in embodiments of the invention pre-defined.

In embodiments of the invention the sub-bands are selected such that some of their boundaries are the same as for the actual bands. How the energy behaves in each region can then be observed, e.g., by calculating energy ratios from sub-band to sub-band. Also, according to the embodiments of the invention is it possible to select the sub-band with the highest energy in order to determine the (probably) most important region. Thus, the embodiments of the invention select bands that reflect these changes in the band boundaries (position and width) as well as allocating enough bits for quantization.

For example when certain sub-bands or larger regions have very little energy, the embodiments of the invention may select an allocation that for example uses wide bands in that region with a low bit allocation for quantization.

For example if the band allocations are in an embodiment of the invention

1) 7-8 kHz, 8-10 kHz, 10-12 kHz, 12-14 kHz and
2) 7-8.5 kHz, 8.5-10 kHz, 10-12 kHz, 12-14 kHz and the Sub-bands have a band-width of 500 Hz, and overlap by 50%—thus for example the first three sub-bands may be 7-7.5 kHz, 7.25-7.75 kHz, and 7.5-8 kHz.

In this example the sub-bands have relative energies 100, 90, 70, 95, 85, 80, 70 in the 7-9 kHz region with some lower energies beyond 9 kHz. The signal energy goes down from 7 kHz to about 7.75 kHz and then goes up from 7.75 kHz to about 8.25 kHz (while again decreasing from about 8.25 kHz onward).

In embodiments of the invention, using this information, the decision logic can conclude that there is probably an important energy peak between 7.75-8.25 kHz (and an even bigger energy peak between 7-7.5 kHz). If in the example embodiment both band allocations 1) and 2) have the same bit allocation in order to simplify the decision logic, the decision logic is configured to determine that by using band allocation 2) allows the later HFR processor to keep the peak between 7.75-8.25 kHz in the same band, which therefore does not force a point of discontinuity during a high-energy peak/region between any two bands.

Furthermore in some embodiments the number of non-overlapping sub-bands may be selected to evaluate the importance of a larger region—for example to determine an estimate for the bandwidth of the original signal.

In some embodiments, the energy estimator decision logic 201 uses the energy ratios between short sub-bands or groups of sub-bands to select the number of bands and each band length.

The flexibility of the energy estimator decision logic 201 in selecting the number and length of the bands is also dependent on the bit rate allocated to band selection and the amount of processing power allocated to the energy estimator decision logic 201.

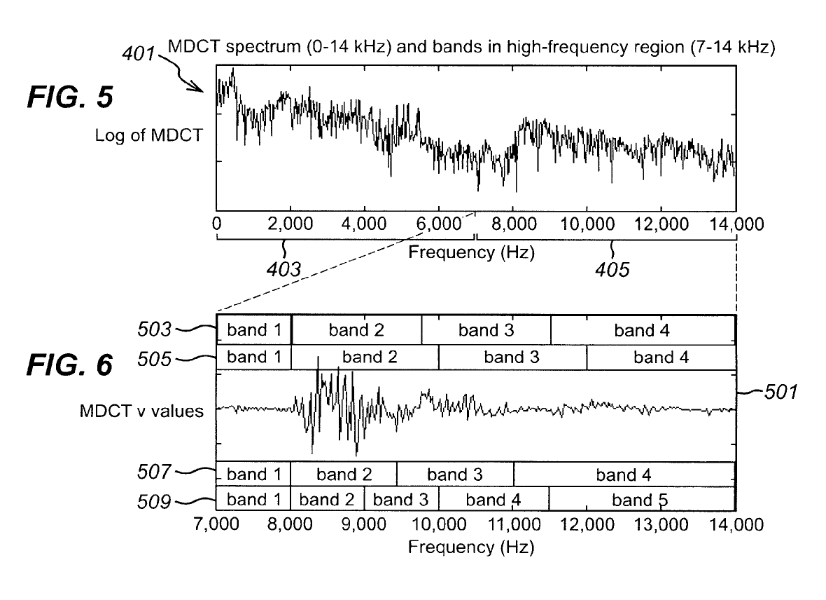

A further example is shown with respect to FIGS. 5 and 6 where the decision logic selects one of four candidate band selections for each frame of the audio signal.

With respect to FIG. 5 an example of the frequency domain representation 401 of a typical audio signal for a single frame of the audio signal is shown. In this example the whole spectrum of the signal is represented as logarithmic modified discrete cosine transform values from 0 to 14 kHz. As would be understood by the person skilled in the art the frequency domain representation may be determined by other frequency coefficient values other than the MDCT values described here. With respect to this specific example the low frequency region represents the frequency components from 0 to 7 kHz and the high frequency region represents the frequency components from 7 kHz to 14 kHz.

With respect to FIG. 6, the high frequency region of FIG. 5 is shown as the absolute MDCT value 501 together with the four possible band selections 503, 505, 507, 509.

The first candidate band selection 503 has four bands, band 1 which represents the frequency components from 7 kHz to 8 kHz, band 2 which represents the frequency components from 8 kHz to approximately 9.75 kHz, band 3 which represents the frequency components from approximately 9.75 kHz to 11.5 kHz and band 4 which represents the frequency components from 11.5 kHz to 14 kHz.

The second candidate band selection 505 has four bands, band 1 which represents the frequency components from 7 kHz to 8 kHz, band 2 which represents the frequency components from 8 kHz to approximately 10 kHz, band 3 which represents the frequency components from approximately 10 kHz to 12 kHz and band 4 which represents the frequency components from 12 kHz to 14 kHz.

The third candidate band selection 507 has four bands, band 1 which represents the frequency components from 7 kHz to 8 kHz, band 2 which represents the frequency components from 8 kHz to 9.5 kHz, band 3 which represents the frequency components from 9.5 kHz to 11 kHz and band 4 which represents the frequency components from 11 kHz to 14 kHz.

The fourth candidate band selection 509 has five bands, band 1 which represents the frequency components from 7 kHz to 8 kHz, band 2 which represents the frequency components from 8 kHz to 9 kHz, band 3 which represents the frequency components from 9 kHz to 10 kHz, band 4 which represents the frequency components from 10 kHz to 11.5 kHz and band 5 which represents the frequency components from 11.5 kHz to 14 kHz.

With respect to this example the energy estimator detection logic 201 may detect that there is significant activity within the sub-bands which represent the frequency components from 8 kHz to 9.5 kHz, whereas there is significantly less activity within the sub-bands which represent the frequency components 7 kHz to 8 kHz and from 9.5 kHz to 11 kHz. The energy estimator detection logic may then select the third band selection candidate 507 as it has a specific band 2 which represents the significant activity region.

This embodiment requires only 2 bits per frame to code which of the 4 candidate band allocations are selected.

When information about the signal bandwidth is known the predefined list may include defined band allocations for the division of the high frequency region into bands which reflect known or determined advantageous band/bit allocations.

In other words, one or more of the band allocations may also include a different bit allocation for quantization and the available bits may then be used mainly for quantizing the lower part of the high-frequency region when there is not much energy above, say, 10 or 12 kHz. However, when the energy is evenly spread throughout the high-frequency region or is greater in the high frequencies than the lower frequencies the candidates selected typically have equal band lengths and the available bit rate for quantization is allocated more evenly between the bands.

Although the above example shows where the energy estimator selection logic is able to select one from four possible candidates, in other embodiments of the invention the energy estimator selection logic 201 may be able select a band allocation from any number of ‘fixed’ or predefined band allocation candidates. These predefined band allocation candidates may be organized as lists. Furthermore although the above examples show only four or five bands per band allocation candidate it would be understood that each candidate may have any number of bands and would not be limited to only four or five bands.

These predefined band allocation candidates may in some embodiments of the invention be permanent allocation candidates, in other words the lists are stored in some permanent or semi-permanent memory store—for example a read only memory.

In some embodiments of the invention these allocation candidates may be updated by a central update process, for example the operator instructing an update process to communication devices operating an audio codec according to the invention. In other embodiments the device operating an audio codec according to the invention may initiate an update of the candidate band allocation list itself. These updatable candidate band allocations may be stored in a re-writable memory store—for example an electronically programmable memory.

Furthermore the energy estimator decision logic 201 in some embodiments of the invention may be configured to generate a band allocation (rather than select one from a number of candidate band allocations) dependent on the determined spectral characteristics.

In one embodiment, the decision logic may generate band allocations and also bit allocations dependant on the bandwidth of the original signal and/or the difference between the energy levels in the lower and the higher frequencies of the original high-frequency region.

In practice a selection of between 4 to 16 different combinations, which reflects a selection bit allocation of 2 to 4 bits per frame is generally preferred. The use of 3 and 4 bit selection allocation may provide more freedom to select very short bands that can be placed with precision in the lower part of the high-frequency region. For example, an additional 12 candidate bands over those indicated with respect to the example shown in FIGS. 5 and 6 in the 4-bit selection allocation case can be used to place, e.g., a 300-Hz band in one of 12 pre-determined over-lapping positions (e.g., with a 200-Hz step) in the region between 7 and 9.5 kHz to cover frequencies that are perceptually more important and also more typical in speech signals.

The 300 Hz band may thus be either an extra band or the lengths of the other bands could simply be adjusted to facilitate this shorter band.

The energy estimator decision logic 201 selection of the bands is shown in FIG. 7 by step 607.

The energy estimator decision logic 201 then sends information to the HFR processor 232 which enable these selected or generated band allocations to be used in the coder 104.

This indication of the band selection effectively performs a controlling operation for the remaining high frequency region coding process and is shown in FIG. 7 by the step 609.

The HFR processor 232 may in one embodiment of the invention perform HFR coding, the selection of low frequency spectral values which may be transposed and scaled to form acceptable replicas of high frequency spectral values. The number and the width of the bands to be used in a method such as described in detail in WO 2007/052088 is therefore selected by the above process. However it would be understood that the invention may be applied to other high frequency region coding processes involving band selection. The HFR processor 232 may in some embodiments of the invention also carry out envelope processing which may assist in the reconstruction of the signal.

The HFR processor 232 is therefore configured to generate a bitstream output which is output to the bitstream formatter 234 which enables a suitable HFR decoder to reconstruct a replica of the high frequency bands selected by the above method from the low frequency coder output.

The high frequency region coding process of producing a bitstream to enable the replication process is shown in FIG. 7 by step 611.

The energy estimator decision logic output is furthermore passed to the bitstream formatter 234. This is shown in FIG. 7 by step 613.

The bitstream formatter 234 receives the low frequency coder 231 output, the high frequency region processor 232 output and the selection output from the energy estimator decision logic 201 and formats the bitstream to produce the bitstream output. The bitstream formatter 234 in some embodiments of the invention may interleave the received inputs and may generate error detecting and error correcting codes to be inserted into the bitstream output 112.

In some embodiments of the invention the HFR processor 232 receives the original low frequency domain signal instead of the synthesized low frequency domain signal from the low frequency coder 231. In these embodiments it is possible to simplify the encoder apparatus as the low frequency coder 231 does not have to be configured to both encode and then decode the low frequency domain signal to generate a synthesized low frequency domain signal for the HFR processor 232.

Furthermore in some embodiments of the energy estimator decision logic receives the original low frequency domain signal and is configured to carry out analysis using information gathered from this signal.

One advantage which may be seen by embodiments employing the invention is that it further improves the matching between the selected low-frequency band and the high-frequency band by allocating such band lengths that maintain important regions (e.g., high-energy regions) within one band whenever possible.

In addition, the embodiments of the invention enable adaptive bit allocation for example for signals with band-limited characteristics using the same criteria as used for the band length selection. Thus embodiments of the invention may allocate more bits to the bands which have an effect on the perceived quality.

Another advantage found in embodiments of the invention is that this improvement only requires a very low additional bit rate over the previous high frequency region coding based processes which will not impact significantly on the performance of applications.

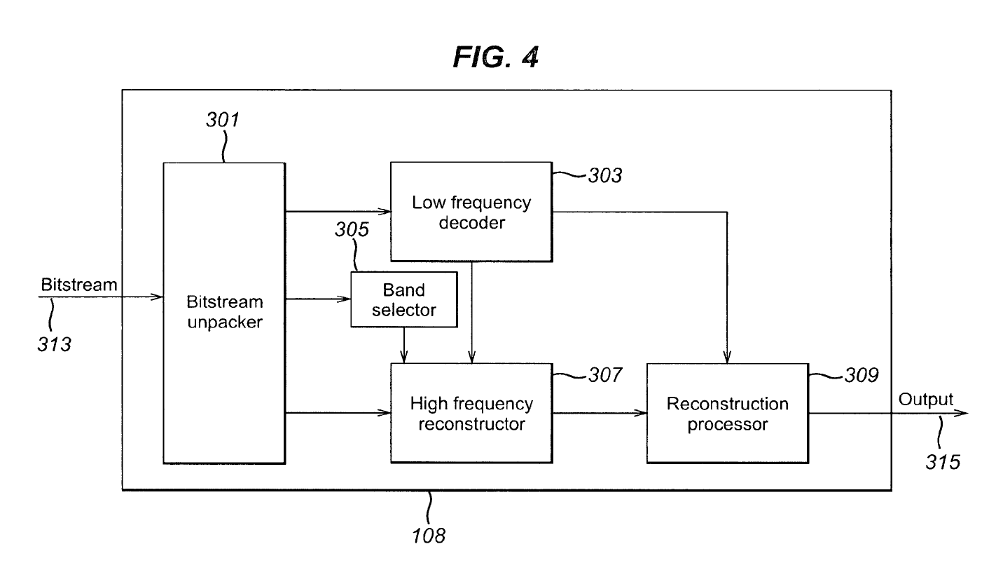

To further assist the understanding of the invention the operation of the decoder 108 with respect to the embodiments of the invention is shown with respect to the decoder schematically shown in FIG. 4 and the flow chart showing the operation of the decoder in FIG. 8.

The decoder comprises an input 313 from which the encoded bitstream 112 may be received. The input 313 is connected to the bitstream unpacker 301.

The bitstream unpacker demultiplexes, partitions, or unpacks the encoded bitstream 112 into three separate bitstreams. The low frequency encoded bitstream is passed to the low frequency decoder 303, the spectral band replication bitstream is passed to the high frequency reconstructor 307 (also known as a high frequency region decoder) and the band selection bitstream passed to the band selector 305.

This unpacking process is shown in FIG. 8 by step 701.

The low frequency decoder 303 receives the low frequency encoded data and constructs a synthesized low frequency signal by performing the inverse process to that performed in the low frequency coder 231. This synthesized low frequency signal is passed to the high frequency reconstructor 307 and the reconstruction processor 309.

This low frequency decoding process is shown in FIG. 8 by step 707.

The band selector 305 receives the band selection bits and either regenerates the bands or selects a band allocation from a list of candidate allocations according to the band selection bits. The band allocation values, the number, location and the width of each band are passed to the high frequency reconstructor 307. In some embodiments of the invention the band selector 305 may be part of the high frequency reconstructor 307.

The selection of bands dependent on the band selection bitstream is shown in FIG. 8 by step 703.

The high frequency reconstructor 307, on receiving the synthesized low frequency signal, band selections and the high frequency reconstruction bitstream constructs the replica high frequency components by replicating and scaling the low frequency components from the synthesized low frequency signal as indicated by the high frequency reconstruction bitstream in terms of the bands indicated by the band selection information. The reconstructed high frequency component bitstream is passed to the reconstruction processor 309.

This high frequency replica construction or high frequency reconstruction is shown in FIG. 8 by step 705.

The reconstruction processor 309 receives the decoded low frequency bitstream and the reconstructed high frequency bitstream to form a bitstream representing the original signal and outputs the output audio signal 114 on the decoder output 315.

This reconstruction of the signal is shown in FIG. 8 by step 709.

The embodiments of the invention described above describe the codec in terms of separate encoders 104 and decoders 108 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device 610, it would be appreciated that the invention as described below may be implemented as part of any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-40. (canceled)

41. An apparatus comprising:
at least one processor and at least one memory including computer program code the at least one memory and the computer program code configured to, with the at least one processor, cause the apparatus at least to:
determine at least one characteristic of the audio signal;
divide the audio signal into at least a low frequency portion and a high frequency portion, and
generate from the high frequency portion a plurality of high frequency band signals dependent on the at least one characteristic of the audio signal; and
determine for each of the plurality of high frequency band signals at least part of the low frequency portion which can represent the high frequency band signal.

42. The apparatus as claimed in claim 41, wherein the at least one memory and the computer program code are further configured to, with the at least one processor, cause the apparatus at least to:
store at least a plurality of band allocations; and
select one of the plurality of band allocations dependent on the at least one characteristic of the audio signal, wherein
the encoder is configured to generate the plurality of high frequency band signals from the application of the selected band allocation to the high frequency portion of the audio signal.

43. The apparatus as claimed in claim 41, wherein the at least one memory and the computer program code are further configured to, with the at least one processor, cause the apparatus at least to:
generate a band allocation dependent on the at least one characteristic of the audio signal; wherein
the encoder is configured to generate the plurality of high frequency band signals from the application of the generated band allocation to the high frequency portion of the audio signal.

44. The apparatus as claimed in claim 42, wherein each band allocation comprises a plurality of bands, wherein at least one band of the plurality of bands is overlapping at least partially with at least one further band of the plurality of bands, and wherein each band comprises at least one of:
a location frequency and a bandwidth; and
a start frequency and a stop frequency.

45. The apparatus as claim in claim 41, wherein the at least one memory and the computer program code are further configured to, with the at least one processor, cause the apparatus at least to:
generate a band allocation signal dependent on the generated plurality of high frequency band signals;
generate a low frequency encoded signal dependent on the low frequency portion of the audio signal;
generate a high frequency encoded signal dependent on the determined at least part of the low frequency portion which can represent the high frequency band signal; and
output an encoded signal comprising: the low frequency encoded signal; the high frequency encoded signal; and the band allocation signal.

46. The apparatus as claimed in claim 41, wherein the at least one characteristic of the audio signal comprises characteristics determined only from the high frequency portion of the audio signal.

47. The apparatus as claimed in claim 41, wherein the at least one characteristic of the audio signal comprises:
energy of components of the audio signal;
peak to valley ratio of components of the audio signal; and bandwidth of the audio signal.

48. A method comprising:
determining at least one characteristic of the audio signal;
dividing the audio signal into at least a low frequency portion and a high frequency portion, and
generating from the high frequency portion a plurality of high frequency band signals dependent on the at least one characteristic of the audio signal; and
determining for each of the plurality of high frequency band signals at least part of the low frequency portion which can represent the high frequency band signal.

49. The method as claimed in claim 48, further comprising:
storing at least a plurality of band allocations; and
selecting one of the plurality of band allocations dependent on the at least one characteristic of the audio signal, wherein
generating the plurality of high frequency band signals comprises applying the selected band allocation to the high frequency portion of the audio signal.

50. The method as claimed in claim 48, further comprising:
generating a band allocation dependent on the at least one characteristic of the audio signal; wherein
generating the plurality of high frequency band signals comprises applying the generated band allocation to the high frequency portion of the audio signal.

51. The method as claimed in claim 49, wherein each band allocation comprises a plurality of bands, wherein at least one band of the plurality of bands is overlapping and at least partially with at least one further band of the plurality of bands, and wherein each band comprises at least one of:
a location frequency and a bandwidth; and
a start frequency and a stop frequency.

52. The method as claimed in claim 48, further comprising:
generating a band allocation signal dependent on the generated plurality of high frequency band signals;
generating a low frequency encoded signal dependent on the low frequency portion of the audio signal;
generating a high frequency encoded signal dependent on the determined at least part of the low frequency portion which can represent the high frequency band signal; and
outputting an encoded signal comprising:
the low frequency encoded signal;
the high frequency encoded signal;
and the band allocation signal.

53. The method as claimed in claim 48, wherein the at least one characteristic of the audio signal comprises characteristics determined only from the high frequency portion of the audio signal.

54. The method as claimed in claim 48, wherein the at least one characteristic of the audio signal comprises:
energy of components of the audio signal;
peak to valley ratio of components of the audio signal; and
bandwidth of the audio signal.

55. An apparatus comprising:
at least one processor and at least one memory including computer program code the at least one memory and the computer program code configured to, with the at least one processor, cause the apparatus at least to:
receive an encoded signal comprising: a low frequency encoded signal; a high frequency encoded signal; and a band allocation signal; and
decode the low frequency encoded signal to produce a synthetic low frequency signal;
generate a synthetic high frequency signal, wherein at least one part of the synthetic high frequency signal dependent on the band allocation signal is generated from at least a portion of the synthetic low frequency signal dependent on at least a part of the high frequency signal.

56. The apparatus as claimed in claim 55, wherein the at least one memory and the computer program code are further configured to, with the at least one processor, cause the apparatus at least to:
combine the synthetic low frequency signal and synthetic high frequency signal to generate a decoded audio signal.

57. The apparatus as claimed in claim 55, wherein the at least one memory and the computer program code are further configured to, with the at least one processor, cause the apparatus at least to:
store at least a plurality of band allocations;
select one of the plurality of ban allocations dependent on the band allocation signal; and
generate a band allocation dependent on the band allocation signal.

58. The apparatus as claimed in claim 57, wherein each band allocation comprises a plurality of bands, and wherein each band comprises at least one of:
a location frequency and a bandwidth; and
a start frequency and a stop frequency.

59. A method comprising:
receiving an encoded signal comprising: a low frequency encoded signal; a high frequency encoded signal; and a band allocation signal; and
decoding the low frequency encoded signal to produce a synthetic low frequency signal;
generating a synthetic high frequency signal, wherein at least one part of the synthetic high frequency signal dependent on the band allocation signal is generated from at least a portion of the synthetic low frequency signal dependent on at least a part of the high frequency signal.

60. The method as claimed in claim 59, further comprising combining the synthetic low frequency signal and synthetic high frequency signal to generate a decoded audio signal.

61. The method as claimed in claim 59, further comprising:
storing at least a plurality of band allocations;
selecting one of the plurality of band allocations dependent on the band allocation signal; and
generating a band allocation dependent on the band allocation signal.

62. The method as claimed in claim 61, wherein each band allocation comprises a plurality of bands, and wherein each band comprises at least one of:
a location frequency and a bandwidth; and
a start frequency and a stop frequency.

63. A computer program product comprising computer readable medium bearing computer program code embodied therein for use with a computer, the computer program code comprising:
determining at least one characteristic of the audio signal;
dividing the audio signal into at least a low frequency portion and a high frequency portion, and
generating from the high frequency portion a plurality of high frequency band signals dependent on the at least one characteristic of the audio signal; and
determining for each of the plurality of high frequency band signals at least part of the low frequency portion which can represent the high frequency band signal.

64. A computer program product comprising computer readable medium bearing computer program code embodied therein for use with a computer, the computer program code comprising:
receiving an encoded signal comprising: a low frequency encoded signal; a high frequency encoded signal; and a band allocation signal;
decoding the low frequency encoded signal to produce a synthetic low frequency signal;
generating a synthetic high frequency signal, wherein at least one part of the synthetic high frequency signal dependent on the band allocation signal is generated from at least a portion of the synthetic low frequency signal dependent on at least a part of the high frequency signal.
